(19) United States
(12) Patent Application Publication
(10) Pub. No.: US 2008/0250097 A1
(43) Pub. Date: Oct. 9, 2008

(54) Method and system for extending the services provided by an enterprise service bus

(75) Inventors: Christophe Angelini, London (GB); Jerome Daniel, Grasse (FR); Nicolas Deslandes, Mougins (FR)

Correspondence Address: YOUNG & THOMPSON, 209 Madison Street, Suite 500, ALEXANDRIA, VA, 22314, US

(73) Assignee: ADADEUS S.A.S, BIOT (FR)

(21) Appl. No.: 11/730,842

(22) Filed: Apr. 4, 2007

(51) Int. Cl. G06F 15/16

(52) U.S. Cl. 709/202

(57) ABSTRACT

In a middleware implementing an enterprise service bus (ESB) for interconnecting disparate software applications a method and a system of extending services provided by the ESB are disclosed. All incoming service requests reaching ESB from end-clients are not only forwarded to a primary server but are all, or an adjustable fraction of all of them, replicated to one or more secondary shadow servers. All replies received by ESB from the primary server and from the secondary shadow servers are validated. Validation includes the forwarding to the end-clients of a single validated reply for each incoming service request while all redundant replies are discarded. Replication of incoming service requests and validation of all replies extend the services provided by an ESB allowing e.g., to warm up a newly installed server, to bring up new software applications, to guarantee the integrity of operation of a cluster of servers and to optimize the response times.

### FIELD OF THE INVENTION

In the framework of a middleware aimed at interconnecting disparate software applications the invention describes a method and a system for extending the services provided by an enterprise service bus (ESB).

### BACKGROUND OF THE INVENTION

Middleware is a family of computer software that permits the interconnection, usually over a network, of disparate software components or applications possibly running across heterogeneous computing platforms. A middleware is often used to support complex distributed applications such as web servers, application servers, content management systems, and more generally to support all the software products and tools part of the information technology (IT) system of any modern large enterprise, company and organization. Use of a middleware is also recognized as a solution to the problem of linking new applications to older legacy systems.

An enterprise service bus (ESB) is then a distributed software architecture implemented from a collection of middleware services which provides integration capabilities. Usually based on open standards it delivers foundational services for more complex architectures via an event-driven and messaging middleware. Hence, if ESB is more a logical concept than it is a product it nevertheless allows applications to be connected to this logical bus through connectors which encapsulate system functionality and provide a layer of abstraction between bus and applications. Through the use of open communication standards connectivity between bus and applications can thus be granted through many transport mediums.

It is then a general object of the invention to extend the services provided by current ESB architectures.

It is a more particular object of the invention to disclose a replication mode of operation which extends ESB services to the domains of bring up, resource sizing, and regression of updated or new software applications in their actual environment.

It is also an object of the invention to allow operating modes such as warm up of new servers and applications, traffic integrity checking mode or to improve response time of critical applications.

Further objects, features and advantages of the present invention will become apparent to the ones skilled in the art upon examination of the following description in reference to the accompanying drawings. It is intended that any additional advantages be incorporated herein.

### SUMMARY OF THE INVENTION

The invention describes in a middleware implementing an enterprise service bus (ESB) for interconnecting disparate software applications a method and a system of extending services provided by the ESB. All incoming service requests reaching ESB from end-clients are not only forwarded to a primary server but are all, or an adjustable fraction of all of them, replicated to one or more secondary shadow servers. All replies received by ESB from the primary server and from the secondary shadow servers are validated. Validation includes the forwarding to the end-clients of a single validated reply for each incoming service request while all redundant replies are discarded. In one mode of operation validation of the replies consists of unconditionally validating the reply coming from the primary server followed, optionally, by the logging, in an error report, of all discrepancies observed in the secondary replies compared to the reply from the primary server. In another mode of operation validating the replies consists in comparing all replies to each other and to consider that validation is only successful if all replies are identical. However, if not successful, the forwarding of a single validated reply is replaced by the forwarding an error message. Yet in another mode of operation validating the replies consists of unconditionally validating the first received reply whichever it is coming from the primary server or from any one of the secondary shadow servers.

### BRIEF DESCRIPTION OF THE DRAWINGS

FIG. 1 depicts the environment of the invention which better takes place in the framework of a middleware implementing an enterprise service bus (ESB)

FIG. 2 describes the components needed to implement the shadow mode of operation of the invention.

FIG. 3 shows a first application of the invention where a shadow server must be warmed up.

FIG. 4 describes another application of the invention which is intended to validate software applications running in secondary shadow servers.

FIG. 5 describes yet another application of the invention that guarantees the integrity of operation of a cluster of servers and, in a further mode of operation, permits also to optimize response times.

### DETAILED DESCRIPTION

The following detailed description of the invention refers to the accompanying drawings. While the description includes exemplary embodiments, other embodiments are possible, and changes may be made to the embodiments described without departing from the spirit and scope of the invention.

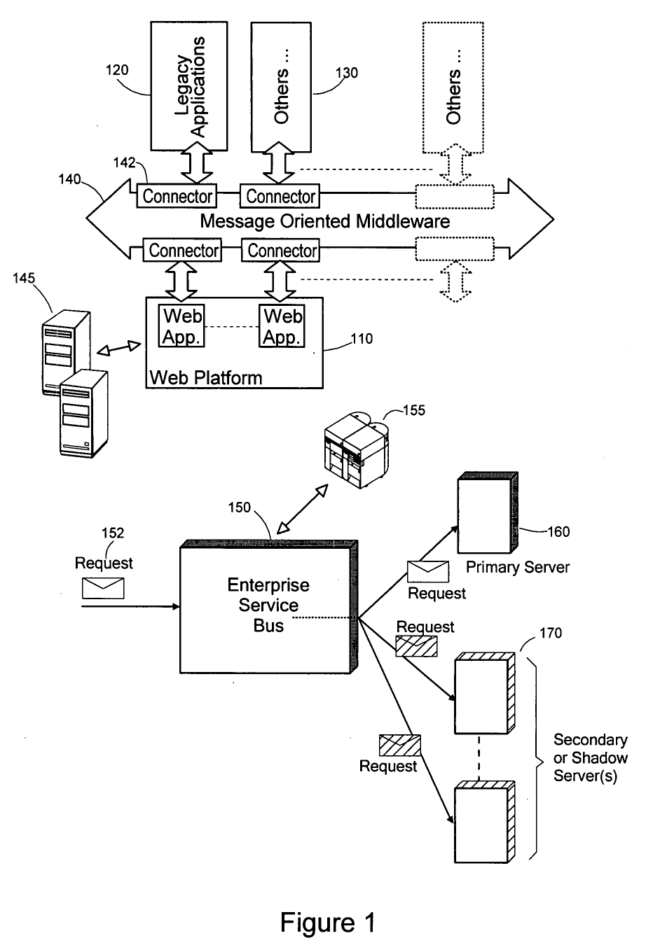

FIG. 1 describes the environment of the invention which better takes place in the framework of a middleware as discussed in the background section; i.e., a product allowing the connection of disparate software components or applications generally across heterogeneous computing platforms (145). This includes distributed applications such as web applications running from servers on a web platform (110), legacy applications (120) running on mainframe computers and all other applications (130) that form the information technology (IT) core of any moderm enterprise. Thus, middleware products are aimed at enabling the connection of multiple applications through an adaption layer, a connector (142), to create larger applications. This is done over an interconnection transport medium or network via an event-driven and standards-based messaging system (140) so that to create a software gateway referred to as an entreprise service bus or ESB (150). Implemented to various degrees of sophistication the ultimate object of any ESB is always to federate all the enterprise applications to have them work in harmony.

In this framework, the invention assumes that ESB (150), running from any standard computing platform (155), includes a traffic replication engine able to duplicate completely or partially the sessions established with the end-users of the enterprise applications. ESB indeed allows the distribution of millions of service requests (152) per day from end-users that are uniquely identifiable so that it is possible to enable or disable the traffic replication on a session and end-user basis. When enabled, traffic replication, if not complete, is specifiable with a defined percentage.

The applications targeted by the normal traffic are called the primary applications, running from a primary server (160), whereas the applications targeted by the replicated traffic are called the secondary applications, running from one or more secondary servers (170).

The traffic replication, secondary applications and secondary servers are also further referred to in the following description of the invention as the shadow mode of operation; i.e., a mode in which ESB has the capability of replicating, partly or totally, the regular traffic to send it to a set of secondary or shadow servers (170). Hence, when the shadow mode is enabled, the requests received by the enterprise services bus (150) have to be sent several times, once to the primary server (160), and replicated as many times as there are secondary or shadow servers (170). In term of flows of traffic, the main processing difference is however in the handling of the replies, returned by the secondary servers, which are either discarded or used by another processing, such as a validation mechanism, further discussed hereafter. Traffic replication can be dynamically activated.

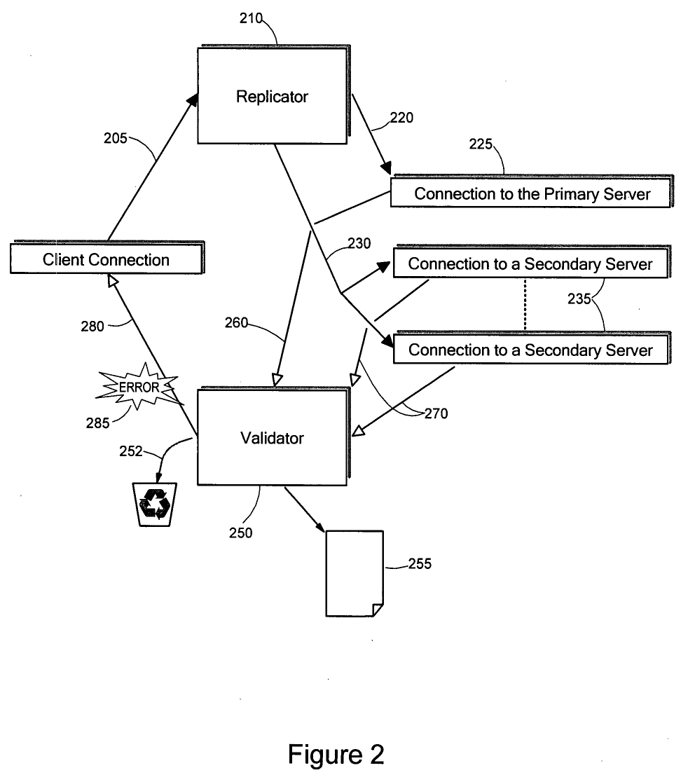

FIG. 2 describes the components needed to implement the shadow mode of operation.

The shadow mode mechanism is based on two main components: a replicator (210), in charge of the traffic replication, and a validator (250) aimed at collecting the replies to apply on them the processing corresponding to one of the running modes of operation further described.

The role of the replicator is thus to create and maintain as many established sessions (230) as there are secondary server(s) (235) for each session (220) that has been established between ESB and a primary application (225). Hence, each time a request (205) reaches the replicator; request's payload is replicated and the appropriate session information related to each targeted secondary server (235) is set by the replicator. Thus, replicator replicates traffic and manages sessions with the secondary applications. Replication of the traffic can be effected on the basis of a fractional percentage of the total traffic value. This percentage refers to the number of sessions replicated towards the secondary applications.

The validator component (250) is in charge of receiving and handling all the replies (260, 270) including the original one from the primary application (260). Validator behaves differently on the received replies depending on which running mode is set. The validator has four specific modes of operation having in common the fact that redundant replies are discarded (252). They are as follows:
In traffic replication only mode, the validator discards all the replies coming from the secondary application(s) (270), thus forwards (280) only the primary application replies (260) to the client application.
In traffic regression mode, the validator compares all secondary replies (270) with the one coming (260) from the primary server. This is the primary server reply which is always returned (280) to the client application. If any of the secondary replies does not match the primary reply a corresponding entry is added into a regression report (255). All replies from the secondary servers are discarded.
In traffic integrity check mode, the validator compares all incoming replies to each other (260, 270), whichever they are coming from the primary (225) or from the secondary server(s) (235). If they are all the same, one of them is elected to be returned to the client application and the others discarded. Otherwise an error message is issued (285) to the client application.
In response time optimization mode, the validator returns the first reply received from any of the primary or secondary server(s). All subsequent replies to the initial query are discarded.

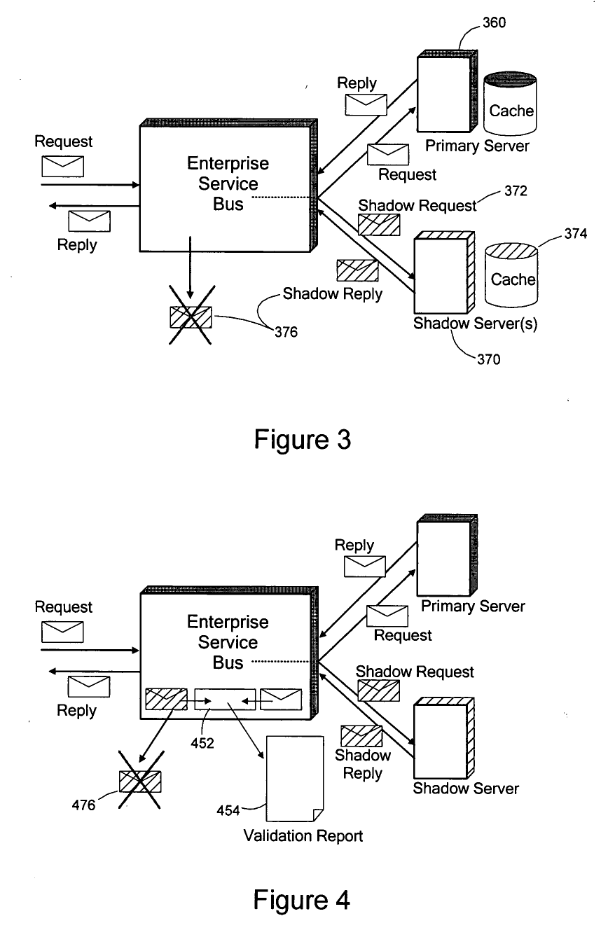

FIG. 3 shows a first application of the invention where a shadow server (370) must be warmed up e.g., after it has been set up in a cluster of servers to eventually replace an active server which must be disabled or to increase the overall computing capacity of the cluster. Before new server can be actually activated server cache (374) must be populated, preferably on real traffic, so that the performance of the newly introduced server will be immediately at par with the active ones (360) when actually turn on. In this application of the invention, the traffic is replicated and sent to one or several standby applications. Hence, the standby applications are expected to use the replicated traffic to populate their local caches. In this mode (i.e.: the traffic replication only mode), used to warm up one or more secondary applications running in shadow server(s) by allowing their caches to be populated on the basis of a real traffic, all the replies returned by the secondary application(s) are just discarded (376) by ESB. When application caches are full enough, replication is stopped and real traffic is sent instead. Each involved shadow server needs to signal ESB the completion of its warm-up phase so that shadow server can start playing an active role handling its share of the regular traffic.

FIG. 4 describes another application of the invention which is intended to validate new or upgraded software applications running in shadow servers in order to assess if resources and capacities put in place are sufficient e.g., before the actual delivering of the corresponding service to end clients or before upgraded software is put into production. In this mode (i.e., the traffic regression mode) ESB duplicates traffic too. Moreover, it needs to compare (452) each reply returned from the primary application with the ones received from the secondary application(s) in order to validate them. As with previous mode all the replies from the secondary application(s) are also discarded (476) during the validation phase. All observed discrepancies or unexpected behavior are logged in a validation report (454).

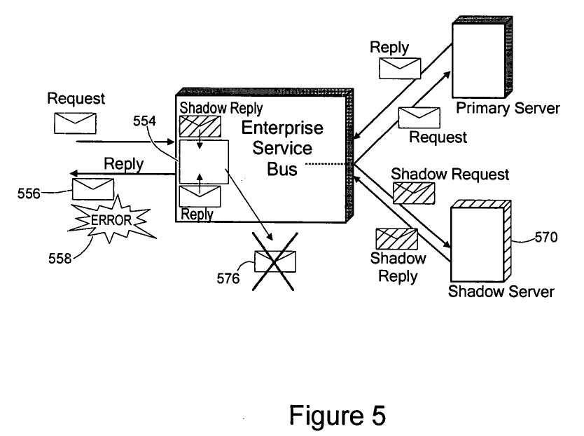

FIG. 5 illustrates an application of the traffic integrity check mode. As with previous applications each request of service is replicated to one or several secondary applications running in shadow server(s) (570). After ESB has collected all replies from the primary and secondary application(s) it compares them (554). If all replies are identical, one of them (556) is returned to the end-user; otherwise an error message is forwarded (458). All redundant replies are discarded (576).

In the response time optimization mode the traffic is, as in the other modes, replicated and addressed to one or several applications in the shadow server(s). However, in this mode the first reply to reach ESB is returned immediately to the end-user whichever it has been issued from the primary or from any of the secondary application(s). Subsequent replies are discarded.

1. A method, in a middleware implementing an enterprise service bus (ESB) for interconnecting disparate software applications, of extending services provided by the ESB, the method in ESB comprising:
forwarding all incoming service requests from end-clients to a primary server (160);
replicating all, or an adjustable fraction of all incoming service requests (205), to one or more secondary shadow servers (170);
receiving all replies from the primary server (260) and from the one or more secondary shadow servers (270);
validating the replies (250), the validating step including the further step of:
forwarding to the end-clients a single validated reply (280) for each incoming service request (205); and, discarding (252) all redundant replies.

2. The method of claim 1 wherein the step of validating the replies (250) consists of unconditionally validating the reply coming from the primary server (260), the method including the further optional step of:
logging, in an error report (255), all discrepancies observed in the secondary replies compared to the reply from the primary server.

3. The method of claim 1 wherein the step of validating the replies (250) consists in comparing all replies to each other and wherein validation is only successful if all replies are identical.

4. The method of claim 3 wherein the step of forwarding a single validated reply is replaced by the step of forwarding an error message (285) if validating step is not successful.

5. The method of claim 1 wherein the step of validating the replies (250) consists of unconditionally validating the first received reply whichever it is coming from the primary server or from any of the one or more secondary shadow servers.

6. A system, in particular an enterprise service bus (150), comprising a replicator means (210) and a validator means (250) adapted for carrying out each step of the method according to claim 1.

7. A computer program product stored on a computer readable storage medium, comprising computer readable code means for causing at least one computer (155) to operate the method of extending the services provided by an enterprise service bus (150) according to claim 1.
